(19) United States
(12) Patent Application Publication
(10) Pub. No.: US 2006/0277259 A1
(43) Pub. Date: Dec. 7, 2006

(54) Distributed sender reputations

(75) Inventors: Elissa E.S. Murphy, Seattle, WA (US); John D. Mehr, Seattle, WA (US); Nathan D. Howell, Seattle, WA (US); Paul S. Rehfuss, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/146,502

(22) Filed: Jun. 7, 2005

(51) Int. Cl. G06F 15/16

(52) U.S. Cl. 709/206

(57) ABSTRACT

Distributed sender reputations are described. In an implementation, a method includes evaluating multiple characteristics of message delivery to establish a reputation for a sender of the message by a mail transfer agent and sharing data which describes the evaluation with another mail transfer agent.

### BACKGROUND

A typical user's interaction with messages received over a network is ever increasing. For example, the user may send and receive hundreds of emails and instant messages in a given day. These messages may provide a wide variety of functionality. However, as the functionality that is available to the user has continued to increase, so too have the malicious uses of this functionality.

One such example is unsolicited commercial email (UCE) messages, otherwise know as “spam”. Spam is typically thought of as an email that is sent to a large number of recipients, such as to promote a product or service. Because sending an email generally costs the sender little or nothing to send, “spammers” have developed which send the equivalent of junk mail to as many users as can be located. Even though a minute fraction of the recipients may actually desire the described product or service, this minute fraction may be enough to offset the minimal costs in sending the spam. Consequently, spammers are responsible for communicating a vast number of unwanted and irrelevant emails. A typical user may receive a large number of these irrelevant emails, thereby hindering the user's interaction with relevant emails. In some instances, for example, the user may be required to spend a significant amount of time interacting with each of the unwanted emails in order to determine which, if any, of the emails received by the user might actually be of interest.

Further, the amount of spam may result in increased costs to communication services that encounter and communicate the spam. For instance, conventional spam filters typically operate once an email has already been received by a message transfer agent (MTA) or by a client. Therefore, the MTA may expend resources in the processing of messages to determine whether the message is spam or “legitimate”. Thus, as the number of messages, and especially spam, continues to increase, so to does the amount of resources needed to analyze the messages. This increase in resources may consume significant resources which otherwise could be used for legitimate purposes, such as the transfer of messages. Additionally, the consumption of resources may leave the MTA vulnerable to attack. For example, a spam attack on such an MTA may force the MTA to use most of its resources in a bid to filter out the spam, allowing a spam sender to effectively disable the MTA.

Therefore, there is a continuing need for techniques that may be employed to limit unwanted messages which are communicated over a network.

### SUMMARY

Distributed sender reputations are described. For example, real-time statistics and heuristics may be constructed, stored, analyzed, and used to formulate a sender reputation for use in evaluating and controlling a given connection between a message transfer agent and a sender. A sender with an unfavorable reputation may be denied a connection before resources are spent receiving and processing email messages from the sender. A sender with a favorable reputation, however, may be rewarded by having some safeguards removed from the connection, which also saves system resources. The statistics and heuristics to be used may include real-time analysis of traffic patterns and delivery characteristics used by an email sender, analysis of content, and historical or time-sliced views of all of the above. These reputations (and/or data utilized to generate the reputations, such as statistics and heuristics) may then be shared between MTAs and clusters of MTAs (such as through a central reputation service) such that collective reputations may be formed for senders which are based on the experience of a plurality of MTAs with the senders. Thus, an MTA may be made aware of an attack on another MTA, and take appropriate action.

### BRIEF DESCRIPTION OF THE DRAWINGS

FIG. 1 is an illustration of an environment operable for communication of messages, such as emails, instant messages, and so on, across a network.

FIG. 2 is an illustration of a system in an exemplary implementation showing a plurality of clients and a plurality of mail transfer agents of FIG. 1 in greater detail.

FIG. 3 is an illustration of an exemplary implementation showing a sender reputation level engine of a reputation module of FIG. 2.

FIG. 4 is an illustration in an exemplary implementation showing a heuristics extraction engine of FIG. 3 in greater detail.

FIG. 5 is a flow diagram depicting a procedure in an exemplary implementation in which control of a connection to an email sender is shown.

FIG. 6 is a flow diagram depicting a procedure in an exemplary implementation in which a reputation is assigned to a new email sender based on a single email message from the new sender.

FIG. 7 is a flow diagram depicting a procedure in an exemplary implementation in which a pre-established sender reputation is used and refined.

FIG. 8 is a flow diagram depicting a procedure in an exemplary implementation in which message throughput and peer sharing are shown.

FIG. 9 is a flow diagram depicting a procedure in an exemplary implementation in which differing mail transfer agent cluster domains share data describing senders to thwart an attack by one of the senders.

FIG. 10 is a flow diagram depicting a procedure in an exemplary implementation in which peer-to-peer communication of data which describes senders is communicated between the peers without use of a central reputation service.

The same reference numbers are utilized in instances in the discussion to reference like structures and components.

### DETAILED DESCRIPTION

Overview

Distributed sender reputations are described. Spam filters today typically operate on clients and scan incoming mail for spam indicators. Although some other systems employ server side filters that analyze incoming mail for the sender information to determine a likelihood of whether the sender is a spammer, server filters operate independently of one another. Therefore, distributed sender reputation techniques are described which may be utilized to share reputations between mail transfer agents (MTAs), MTA cluster domains, and so on.

In one or more implementations, a centralized system is also described that coalesces sender reputation information into a central repository to enable detection of a spam, virus attacks and other malicious activities against a group of mail servers. For instance, MTAs may review incoming messages to identify information about the sender. Reputation information is then stored on a “per sender” basis and shared on a peer-to-peer basis with other MTAs and the central repository. The central repository may store sender information, aggregate this information, and take action on the aggregated sender reputation information by providing the MTAs with updated sender reputation information to be used for filtering messages and senders of messages.

In the following discussion, an exemplary environment is first described which is operable to provide distributed sender reputation techniques. Exemplary procedures are then described which are operable in the described exemplary environment, as well as in other environments.

Exemplary Environment

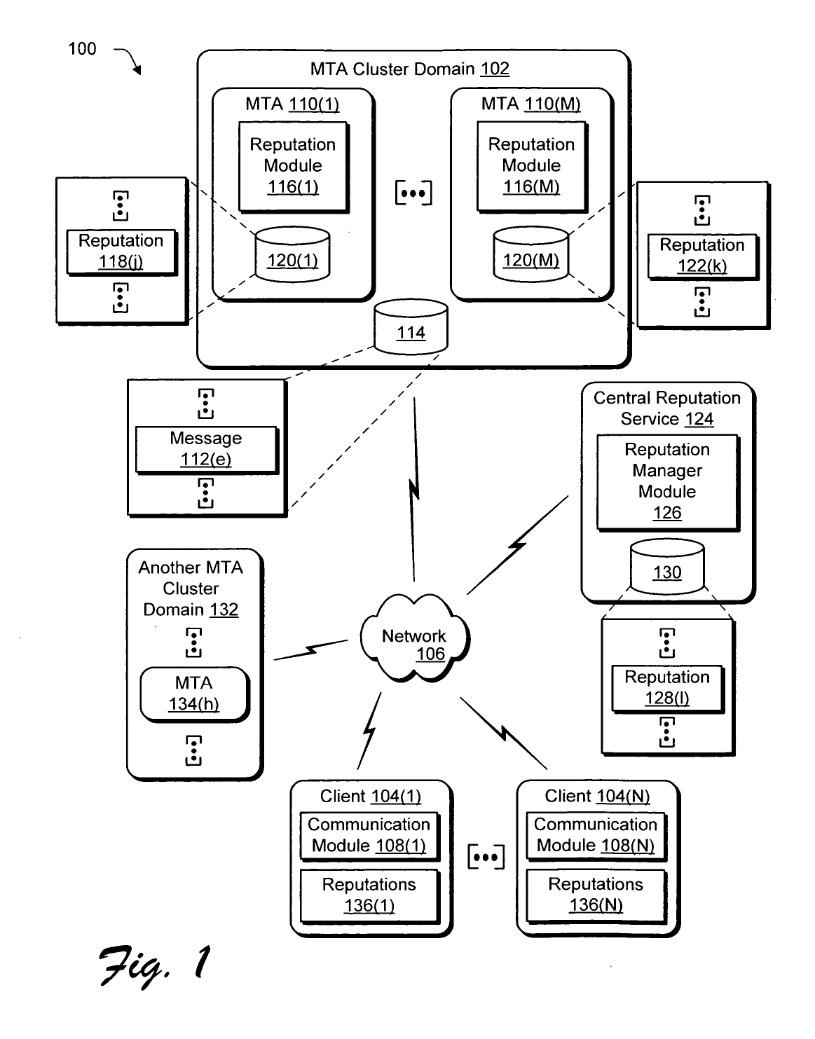

FIG. 1 is an illustration of an environment 100 operable for communication of messages across a network. The environment 100 is illustrated as including an MTA cluster domain 102 which is communicatively coupled to plurality of clients 104(1)-104(N) over a network 106. The plurality of clients 104(1)-104(N) may be configured in a variety of ways. For example, one or more of the clients 104(1)-104(N) may be configured as a computer that is capable of communicating over the network 106, such as a desktop computer, a mobile station, a game console, an entertainment appliance, a set-top box communicatively coupled to a display device, a wireless phone, and so forth. The clients 104(1)-104(N) may range from full resource devices with substantial memory and processor resources (e.g., personal computers, feature-rich wireless phones) to low-resource devices with limited memory and/or processing resources (e.g., personal digital assistants). In the following discussion, the clients 104(1)-104(N) may also relate to a person and/or entity that operate the client. In other words, client 104(1)-104(N) may describe a logical client that includes a user and/or a machine.

Additionally, although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. For instance, clients 104(1)-104(N) may be communicatively coupled via a peer-to-peer network to communicate, one to another. Each of the clients 104(1)-104(N) may also be communicatively coupled to the MTA cluster domain 102 over the Internet. A variety of other instances are also contemplated.

Each of the plurality of clients 104(1)-104(N) is illustrated as including a respective one of a plurality of communication modules 108(1)-108(N). In the illustrated implementation, each of the plurality of communication modules 108(1)-108(N) is executable on a respective one of the plurality of clients 104(1)-104(N) to send and receive messages. For example, one or more of the communication modules 108(1)-108(N) may be configured to send and receive email. Email employs standards and conventions for addressing and routing such that the email may be delivered across the network 106 utilizing a plurality of devices, such as routers, other computing devices (e.g., email servers), and so on. In this way, emails may be transferred within a company over an intranet, across the world using the Internet, and so on. An email, for instance, may include a header, text, and attachments, such as documents, computer-executable files, and so on. The header contains technical information about the source and oftentimes may describe the route the message took from sender to recipient.

In another example, one or more of the communication modules 108(1)-108(N) may be configured to send and receive instant messages. Instant messaging provides a mechanism such that each of the clients 104(1)-104(N), when participating in an instant messaging session, may send text messages to each other. The instant messages are typically communicated in real time, although delayed delivery may also be utilized, such as by logging the text messages when one of the clients 104(1)-104(N) is unavailable, e.g., offline. Thus, instant messaging may be thought of as a combination of e-mail and Internet chat in that instant messaging supports message exchange and is designed for two-way live chats. Therefore, instant messaging may be utilized for synchronous communication. For instance, like a voice telephone call, an instant messaging session may be performed in real-time such that each user may respond to each other user as the instant messages are received.

In an implementation, the communication modules 108(1)-108(N) communicate with each other through use of the MTA cluster domain 102. The MTA cluster domain 102 includes a plurality of mail transfer agents 110(1)-110(M). The MTAs 110(1)-110(M) may be arranged in a variety of ways to provide a wide variety of functionality, such as load balancing and failover. The MTAs 110(1)-110(M) in the environment 100 of FIG. 1 are responsible for communication of messages between the plurality of clients 104(1)-104(N) over the network 106. For instance, the MTA cluster domain 102 may store a message received by the client 104(1) with a plurality of messages 112(e), where “e” can be any integer from one to “E”, in storage 114. Client 104(N), when logging on to a communication service having to the MTA cluster domain 102, may then retrieve messages from the client's account. Thus, in this example the MTA cluster domain 102 is included as a part of a communication service for the communication of messages through use of client accounts.

Each of the plurality of MTAs 110(1)-110(M) is illustrated as including a respective one of a plurality of reputation modules 116(1)-116(M). The reputation modules 116(1)-116(M) are executable to employ techniques to create reputations for email senders. For example, MTA 110(1) may execute the reputation module 116(1) to create a plurality of reputations 118(j) (where “j” can be any integer from one to “J”) which are illustrated as stored locally in storage 120(1) on the MTA 110(1). Likewise, MTA 110(M) may execute the reputation module 116(M) to create a plurality of reputations 122(k) (where “k” can be any integer from one to “K”) which are illustrated as stored locally in storage 120(M) on the MTA 110(M).

In an implementation, the reputations 1180), 122(k) are independent from any individual message sent by the email sender. The reputations 118(j), 122(k) may be utilized to relieve the MTA server cluster 102 from examining individual messages once a reputation established for a sender causes a connection from the sender to be blocked. These reputations 1180), 122(k) may be utilized for a variety of messages, such as messages communicated via a computing system, a cell phone system, a communications system, and so on, or by other systems that can receive a “spam” or a malicious communication.

In an implementation, rather than spending resources filtering individual messages sent from a sender who has an unfavorable reputation, the MTA server cluster 102 (and more particular MTAs 110(1)-110(M) within the cluster) may conserve resources by simply “turning off” the sender before messages are received, e.g., by denying or terminating an IP connection with the sender. For senders with favorable reputations, the MTA server cluster 102 can also save resources by terminating spam filtering and other unnecessary safeguards in proportion to the quality of the sender's favorable reputation.

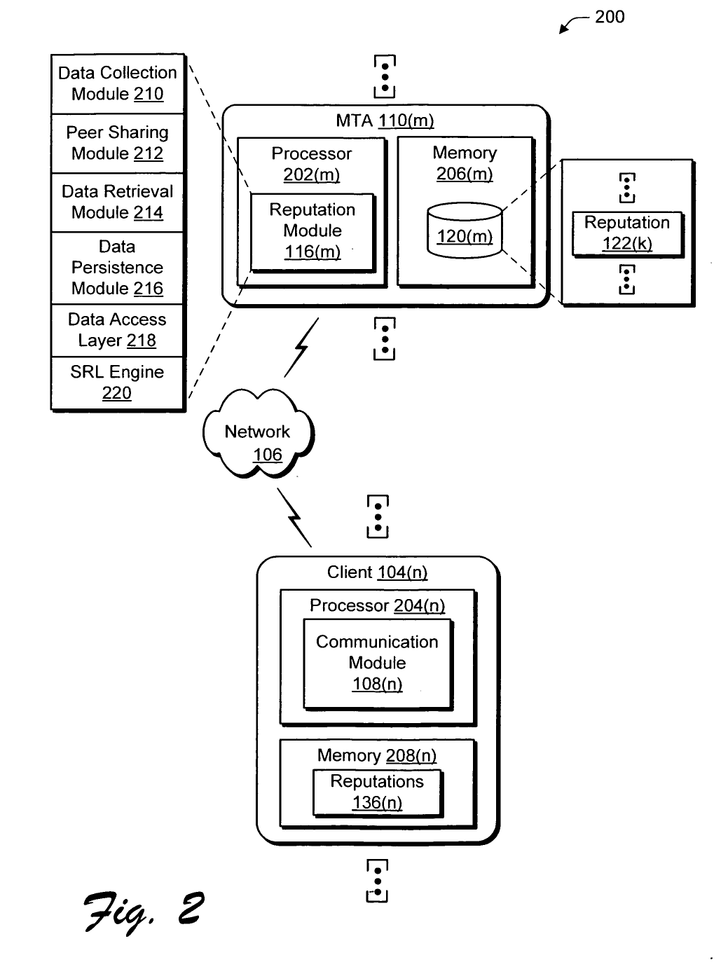

Real-time statistics and heuristics used to determine sender reputations may be constructed, stored, analyzed, and used to formulate a sender reputation level for later use in evaluating a sender connecting to one of the plurality of MTAs 110(1)-110(M) of the MTA server cluster 102. The statistics and heuristics described may include real-time analysis of traffic patterns between a given sender and the plurality of MTAs 110(1)-110(M), content (email) based analysis, and historical or time-sliced views of all of the above, further discussion of which may be found in relation to FIG. 2.

The reputation modules 116(1)-116(M) are executable by the respective MTAs 110(1)-110(M) to distribute the respective pluralities of reputations 118(j), 122(k). For example, reputation module 116(l) may communicate the plurality of reputations 118(j) to MTA 100(M) such that MTA 100(M) is made aware of the experience of MTA 110(1) with particular senders.

In another example, the plurality of MTAs 110(1)-110(M) may communicate the reputations 118(j), 122(k) over the network 106 to a central reputation service 124, which are illustrated as having a plurality of reputations 126(l) (where “l” can be any integer from one to “L”) which are stored in storage 128. The central reputation service 124 may employ a reputation manager module 126 to aggregate the received reputations and communicate a result of this aggregation to each of the plurality of MTAs 110(1)-110(M). Additionally, the central reputation service 124 may receive reputations from another MTA cluster domain 132 having a plurality of MTAs 134(h), where “h” can be any integer from one to “H”. In this way, different MTA cluster domains (e.g., MTA cluster domain 102 and the other MTA cluster domain 132) may be made aware of sender reputations collectively, without having to personally gain experience with each of the senders.

The reputations may be distributed in a variety of ways. For example, the plurality of MTAs 110(1)-100(M) may communicate, one to another, over a peer-to-peer network. Additionally, the plurality of MTAs 110(1)-110(M) may communicate with the central reputation service 124 over the network 106, e.g., the Internet. Thus, data (e.g., statistics and reputations) established for a sender may be communicated amongst a cluster of MTAs 102. This sharing may be done efficiently at a relatively low level, similar in a manner to software-based load balancers that broadcast information across the network to dynamically allocate new connections to a given host.

As MTAs 110(1)-110(M) with the MTA cluster domain 102 receive and share new information about traffic destined for the enterprise they represent, the information to establish a sender reputation may be dynamically recalculated, thereby improving response time and prevention of malicious SMTP behavior, e.g., spam, DOS attack, and so forth.

The central reputation service 124 works with MTAs 110(1)-110(M), 134(h) to further protect against attack. As previously described, the central reputation service 124 acts as a collector, aggregator and propagator of reputations to the MTAs 110(1)-110(M), 134(h). Additionally, the central reputation service 124 may utilize information to generate reputations which is not collected from the MTAs 110(1)-110(M), 134(h). For example, the central reputation service 124 may collect data from third parities and other independent data sources for use generating the reputations, such as from services that provide information about senders for attack prevention and mitigation of false positives for components subscribing to the reputation service.

The clients 104(1)-104(N) may also include respective reputations 136(1)-136(N) distributed from the MTA cluster domain 102. For instance, the central reputation service, through execution of the reputation manager module 126, may distribute aggregated reputations to each of the plurality of clients 104(1)-104(N) such that the clients may also use reputation based filtering of messages. Further, more than one central reputation service 124 may be provided, such that the reputation manager modules may communicate reputations between the services. A variety of other instances are also contemplated.

Generally, any of the functions described herein can be implemented using software, firmware (e.g., fixed logic circuitry), manual processing, or a combination of these implementations. The terms “module” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the distribution strategies described below are platform-independent, meaning that the strategies may be implemented on a variety of commercial computing platforms having a variety of processors.

FIG. 2 is an illustration of a system 200 in an exemplary implementation showing the plurality of clients 104(n) and the plurality of MTAs 110(m) of FIG. 1 in greater detail. MTA 110(m) is representative of any one of the plurality of MTAs 110(1)-110(M) of FIG. 1. Likewise, client 104(n) is representative of any of the plurality of clients 104(1)-104(N) of FIG. 1. The MTAs 110(m) are illustrated as being implemented as servers and the clients 104(n) are illustrated as client devices. Each of the plurality of MTAs 110(m) and the plurality of clients 102(n) of FIG. 2 is illustrated as including a respective processor 202(m), 204(n) and a respective memory 206(m), 208(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 206(m), 208(n) is shown for the respective MTAs 110(m) and clients 104(n), a wide variety of types and combinations of memory may be employed, such as random access memory (RAM), hard disk memory, removable medium memory, and so forth.

A sender's reputation may be based on multiple characteristics, such as certain features of the mail delivery processes employed by the sender/spammer. Spam senders typically use various features of the mail delivery process in characteristic ways that can be counted (e.g., across numerous email messages) and subjected to statistical treatment in order to build a reputation for each sender.

For example, the reputation module 116(m), when executed, may analyze characteristics which result in determination of reputations 122(k) which are stored in storage 120(m). In an implementation, the reputation module 116(m) dynamically updates the reputations 122(k) in real time as messages are received from each sender. In another implementation, reputations are built offline by analyzing a repository of messages, e.g., the storage 114 having the plurality of messages 122(e) of FIG. 1. Dynamic updating of a sender's reputation can signal long-term changes in the sender's intentions or can signal a sudden change in the sender, such as an abrupt onset or an abrupt abandonment of malicious spamming behavior. More specifically, the sudden change can act as a detector of a machine or mail server being compromised and used for malicious activity, e.g., as a “zombie”, “open proxy”, and so on.

The sender reputations may be established by the reputation module 116(m) by analyzing a number of different heuristics and subjecting the results to an intelligent filter to probabilistically classify the results and rank the sender. “Heuristic,” as used herein, may refer to a common-sense “rule of thumb” that increases the chances or probability of a certain result. In the instant case, a heuristic is an indicator that addresses the probability that a sender of a message is a spammer, who merits a “low” or unfavorable sender reputation. The reputation rankings (“levels”) thus arrived at via the heuristics may be used to proactively filter mail to be received from the sender.

Multiple tests or “evaluations” for determining a senders reputation can be performed by the reputation module 116(m). The evaluations may apply a collection of heuristics to a delivery process used by a sender in order to arrive at a reputation level for the sender. Exemplary heuristics may include whether the sender is using an open proxy, whether the sender has sent mail to a trap account, the number of unique variables in the sender's commands, and other factors that indicate that a sender is more or less likely to be a spammer, apart from or in addition to the textual content of the sender's messages.

The reputation module 116(m) is illustrated as including a plurality of sub-modules which are representative of functionality of the reputation module 116(m). The data collection module 210 is representative of functionality that monitors the transport and/or protocol layer of SMTP within the MTA 110(m) and captures reputation statistics and indicators that are stored on a per-sender basis. The data collection module 210 also includes functionality to gather heuristics on a per-message and/or per-session basis after the transport or protocol layer of SMTP has completed, e.g., post-DATA command, and so forth. Although illustrated within the MTA 10(m), this module may reside “outside” of the MTA 110(m) for use in providing raw data to the central reputation service 124 of FIG. 1.

The peer sharing module 212 is representative of functionality that broadcasts data relating to a sender to other MTAs. The peer sharing module 212 may be executable such that a given MTA may act on its own respective information without waiting for data from a peer. The peer sharing module 212 may also operate asynchronously to message flow and act to communicate between other MTAs in the MTA cluster domain 102 as well as with the central reputation service 124.

The data retrieval module 214 is representative of functionality for retrieving a given sender's existing reputation from a reputation store, e.g., reputations 118( ) from storage 120(m) via a data access layer 218. This may be performed at the beginning of a new SMTP session from a sender. At the end of the SMTP session, these heuristics may be updated based on the results of the data collection module 210 during the given session. Additionally, the data retrieval module 214 may be responsible for periodically retrieving sender reputations from the central reputation service 124 and merging them with reputations of the MTA.

The data persistence module 216 is representation of functionality for persisting reputations and data utilized to generate reputations via the data access layer 218. The data access layer 218 provides techniques for accessing, retrieving, inserting and updating information in a data persistence store, e.g., storage 120(m). The data persistence store (e.g., storage 120(m)) may be configured in a variety of ways, such as a database, a flat file format or other type of data repository.

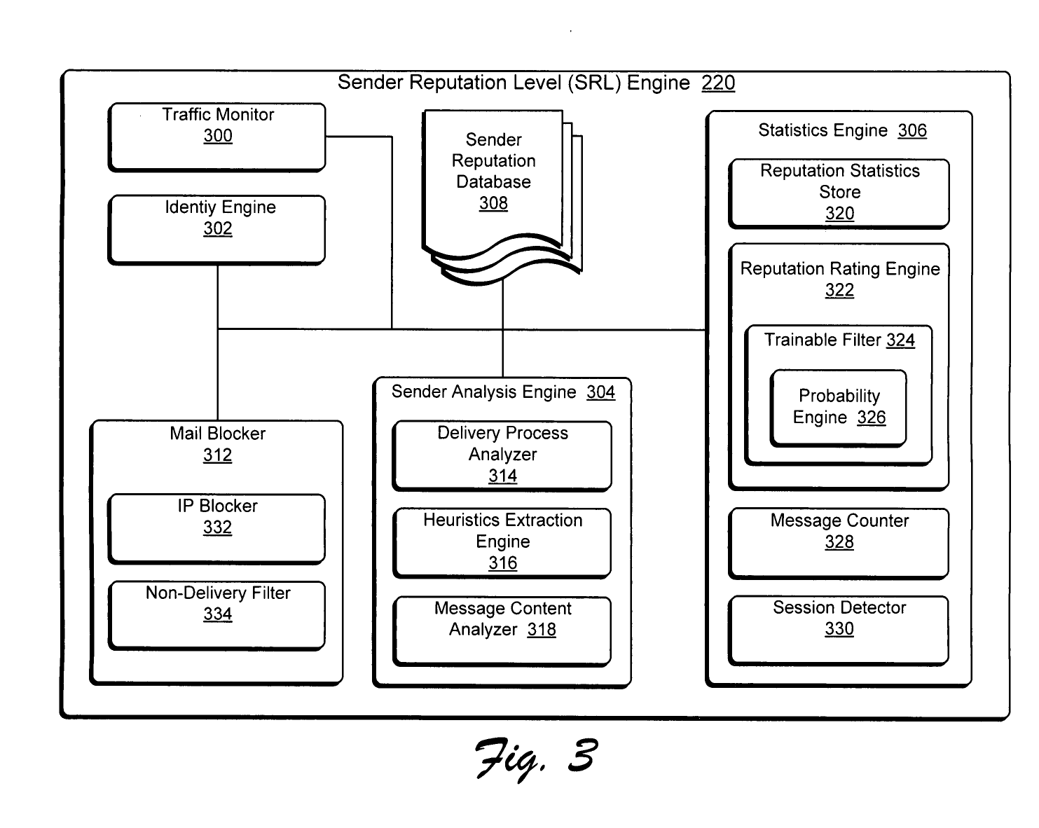

The reputation module 116(m) is also illustrated as including a sender reputation level (SRL) engine 220 which is representative of functionality for determining a sender's reputation. The SRL engine 220 utilizes reputation statistics and indicators to calculate an integer value with a given scale that represents the known behavior or reputation of the sender. The SRL engine 220 may utilize machine learning approaches, either offline or online, which allows this calculation to be probabilistic. The output may then be mapped to a given value range. Although illustrated within the reputation module 116(m), the SRL engine 220 may also be employed by the central reputation service 124 (e.g., the reputation manager module 126) based on information received from the MTAs 110(m) as well as other sources. Further discussion of the SRL engine may be found in relation to FIG. 3.

The sharing of reputations and data utilized to generate reputations can provide a wide variety of functionality. The reputations may create a “virtual shield” across the MTAs 110(1)-110(M) to prevent attack by utilizing not only locally seen/stored information about a sender to establish a reputation, but also information provided by others, such as other MTAs, other MTA clusters domains 132, the central reputation service 124, and so on. This functionality may prevent attacks in a more efficient manner. For instance, load balancing SMTP connections across the MTA cluster domain 102 may result in a vulnerability, in that, attacks may be made against one MTA with other MTAs in the cluster being unaware of the attack. For example, this may occur when utilizing DNS round-robining for load balancing, in that a particular attacker may “stick” to a particular server using a cached DNS lookup. Distributing the reputations and/or data utilized to generate the reputations across the MTAs 110(1)-110(M) allows the MTA cluster domain 102 to detect and prevent an attack regardless of which MTA is being attacked.

This functionality may also be applied towards outbound mail leaving an organization. Senders who utilize an organization's MTAs for sending outbound mail without authentication and enforced limitation may be monitored using the same types of heuristics and building of reputation across MTAs. This then allows a distributed reputation module that may detect and aid in the ability to shut down exploitation of an organization's output mail servers. Further, this may help to prevent degradation of an organization's reputation with receivers of its outbound messages.

FIG. 3 is an illustration of a sender reputation level engine 220 of a reputation module 116(m) of FIG. 2 in an exemplary implementation. The example configuration includes a traffic monitor 300, an identity engine 302, a sender analysis engine 304, and a statistics engine 306, as well as other components, communicatively coupled as illustrated. Other implementations of an SRL engine 220 may be constructed by those skilled in the art upon reading the description herein. It is worth noting that an SRL engine, such as the illustrated exemplary SRL engine 220, may be implemented as a module, and therefore as software, hardware, or combinations of hardware, software, firmware, and so on.

In an exemplary SRL engine 220, the traffic monitor 300 connects to certain layers of an email network, providing an interface between the email network and the SRL engine 220 in order to be able to examine individual email messages and gather statistics about senders. The traffic monitor 300 may include software that monitors the transport or protocol layer of SMTP within the MTA 110(m) of FIG. 2. From the monitored data, an identity engine 302 seeks to identify the sender of each individual email message. In one implementation, a sender can be identified (or defined) simply as a full 32-bit IP address.

The sender analysis engine 304 captures heuristic indications (“indicators”) that can then be stored in the reputation statistics store 320 on a per-sender basis. The sender analysis engine 304 can also gather heuristics on a per-message and/or per-session basis after the transport or protocol layer of SMTP has completed (e.g., post-DATA command, etc.). The statistics engine 306, to be discussed below, develops these heuristic indications into a reputation.

The sender analysis engine 304, which may evaluate a whole collection of email characteristics, may deploy a battery of such evaluations on an individual email message, including tests on many of the aspects of the delivery process used to send the message. These tests generate indicators, that is, heuristic results that may be processed into reputation statistics.

Accordingly, the sender analysis engine 304 may include components, such as a delivery process analyzer 314, a heuristics extraction engine 316, and a message content analyzer 318. The delivery process analyzer 314 specializes in analysis of the characteristics of a sender's delivery process. The heuristics extraction engine 316, to be discussed more fully with respect to the following figure, may include a collection of formulas and/or algorithms for performing the evaluations. The aforementioned message content analyzer 318 may also be included to augment the analysis of the delivery process. In some implementations, the message content analyzer 318 provides a content indication that may be used as a reputation baseline or as one among many heuristics for determining a sender's reputation.

The statistics engine 306 determines a reputation for a sender from the heuristic indicators extracted by the sender analysis engine 304. The reputations determined by the statistics engine 306 may be stored in a sender reputation database 308. When reputation statistics and indicators are updated at the end of an SMTP session, they can be inserted back into a reputation statistics store 320, e.g., via the data access layer. Updated reputations or reputation levels can be inserted back into the sender reputation database 308.

In some implementations, a data access layer portion of the exemplary SRL engine 220 accesses, retrieves, inserts, and updates information in the reputation statistics store 320 and in the sender reputation database 308, or another data persistence store. Although a reputation statistics store 320 and a sender reputation database 308 are illustrated in FIG. 3 for persisting reputation indicators, statistics, and levels, these data for a given sender can be stored in other suitable locations, e.g., in a store that is independent or isolated from a given MTA 110(m). A suitable location can be a database, flat file, or other type of data repository that preferably has the ability to keep information associated with each sender in a normalized format, where the sender identity, e.g., as established by the identity engine 302, is the primary reference.

A reputation rating engine 322 included in the statistics engine 306 determines or estimates a sender's reputation level using the stored heuristic indicators. Thus, in one implementation the reputation rating engine 322 includes a trainable filter 324, to be discussed more fully below, that may include a probability engine 326 for applying statistical formulas and algorithms to the heuristic indicators.

The statistics engine 306 just described may also include a message counter 328 to keep track of the number of messages associated with a given sender and a session detector 330 to keep track of the beginning and end of an SMTP or other email exchange session in order to track changes in a sender's reputation resulting from the communications that occur during an SMTP session.

In one implementation, the reputation rating engine 322 uses the statistics and indicators stored in the reputation statistics store 320 to calculate an integer value within a given scale that represents the behavior or reputation level of a sender. A machine learning approach, either offline or online, allows this calculation to be probabilistic. The output can then be mapped to a specified value range.

The exemplary SRL engine 220 may also include a mail blocker 312 that uses sender reputations to proactively block connections and/or block spam and other undesirable email sent by the sender. The mail blocker 312 may retrieve a sender's reputation, if any, from the sender reputation database 308 and compare a reputation level with a threshold, e.g., an administrator-specified threshold. If the sender's reputation is not acceptable with respect to the threshold, then the mail blocker 312 may include an IP blocker 332 to deny or terminate an SMTP connection to the sender. A non-delivery filter 334 may be included to block further delivery of spam and other undesirable email from recipients further downstream in implementations in which the SRL engine 220 still receives or allows an MTA 100(M) to receive and analyze messages so that the received messages can be used to dynamically update sender reputations.

The mail blocker 312 may retrieve a given sender's existing reputation from the sender reputation database 308, e.g., via the data access layer. This may be performed at the beginning of a new SMTP session from a sender. At the end of the SMTP session, heuristics may be updated based on results determined by the sender analysis engine 304 and the statistics engine 306 during a session interval determined by the session detector 330.

The components, including the mail blocker 312 just described, may be communicatively coupled as illustrated in FIG. 3. In an alternative implementation, an SRL engine 220 includes a reduced number of components to perform email blocking but not analysis and modification of reputations. Such a streamlined implementation may include, for example, only the traffic monitor 300, the identity engine 302, the sender reputation database 308, and the mail blocker 312, but not the sender analysis engine 304 or the statistics engine 306.

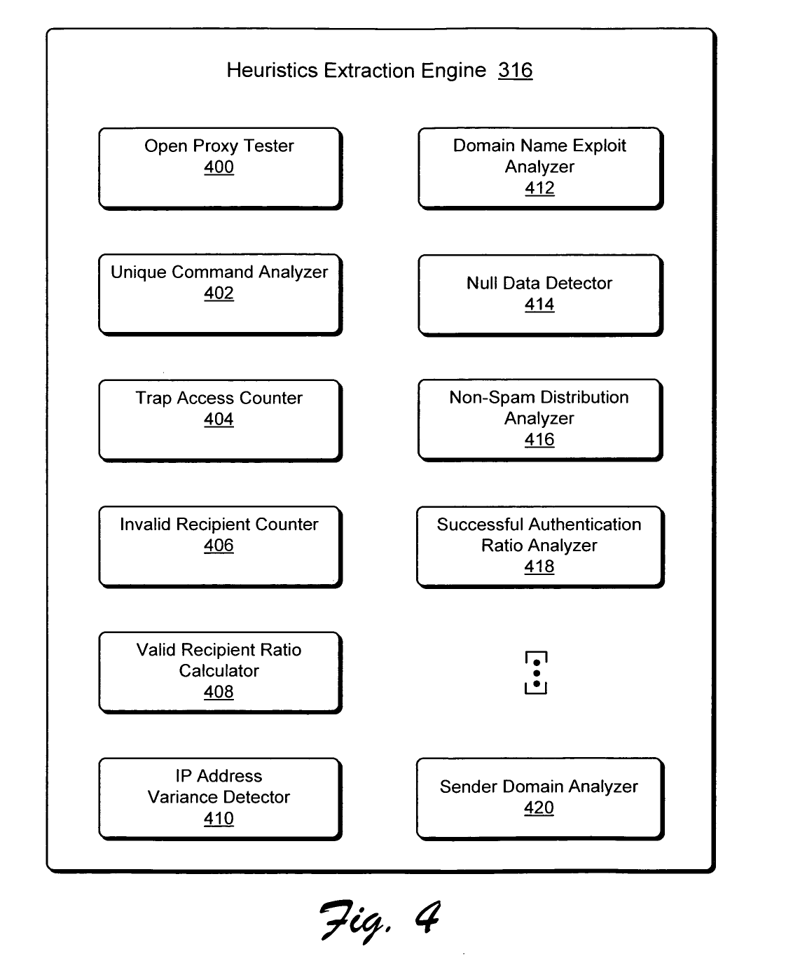

FIG. 4 is an illustration in an exemplary implementation showing the heuristics extraction engine 316 of FIG. 3 in greater detail. In the illustrated implementation, the exemplary SRL engine 220 may utilize heuristics in combination with a machine learning approach that allows each MTA 110(m) to evaluate senders connecting to it, that is, uses real-time sender specific information collected on the MTA 110(m) to establish reputations for senders over time and then applies the reputations towards future attempts.

The illustrated heuristics extraction engine 316 presents an example configuration. Alternative implementations of a heuristics extraction engine 316 may be constructed by those skilled in the art upon reading the description herein. It is worth noting that an exemplary heuristics engine may be implemented in software, hardware, or combinations of hardware, software, firmware, and so on.

Each heuristic may be collected or evaluated by a discrete component, as illustrated in FIG. 4. Alternatively, an exemplary heuristics extraction engine 316 may combine tests for two or more heuristics into a single component or software code. Some components may use or collect deterministic Boolean values. Ratios and distributions that improve or worsen a sender's reputation can be continually updated as more traffic arrives from the sender. Results can also be split into time-sliced views, expanding the overall utility and quantity of the heuristics.

An open proxy tester 400 may determine the current open proxy status of a given sender. A value can be determined by an external component that performs open proxy testing against senders and/or by utilizing a third-party list of open proxies. As much as 60-80% of spam currently on the Internet is estimated to originate from exploited open proxies or from “zombies” (i.e., exploited end-user personal computing machines).

A unique command analyzer 402 gathers indicators related to use of the SMTP verbs “HELO,” “Mail From,” “RCPT,” etc. For example, in one implementation the unique command analyzer 402 aims to determine an integer that represents the total unique values that have been provided by a sender in each of their HELO/EHLO SMTP commands over a given time-frame. A majority of benign senders send their email messages using a finite number of HELO/EHLO statements. Malicious senders may continually modify this value in an attempt to disguise themselves from an administrative view of system behavior.

A trap access counter 404 may be included in the heuristics extraction engine 316 to provide an indication of attempted access to trap recipients, a probable indication of spamming activity. An MTA 110(M) may populate or designate a list of recipients within an organization (supported domains at the MTA level) that are deemed traps, or “honey pots.” This indicator represents the number of recipient attempts against trap accounts by a given sender. Trap accounts represent recipients that should otherwise never be receiving email. If a spammer utilizes a list of account names in order to mine a domain's namespace, the sender will probably eventually submit requests to send email to a trap account. This provides a metric for identifying the sender as a spammer.

An invalid recipient counter 406 aims to detect the number of RCPT attempts by a sender that have failed due to the recipient not existing within the organization. Benign senders typically have a value slightly above zero for this heuristic because the originating sender of an email may perform a typo when entering a legitimate recipient's address or a legitimate recipient may have previously existed but was later removed. Bad senders, however, often have a relatively high invalid recipient count when attempting to mine the namespace of the organization.

A valid recipient ratio calculator 408 tracks a value that represents a ratio of valid versus invalid RCPT attempts by a sender. This heuristic may be set up as a derivative function of the invalid recipient counter 406 described above, and may be useful in helping to catch dictionary attack attempts, and namespace mining from malicious senders.

An IP address variance detector 410 aims to produce a value representing the number of times a sender submits a HELO/EHLO statement that contains an IP address that does not match the originating IP of the SMTP session. In many cases, a legitimate sender provides their IP address in the HELO/EHLO statement. Malicious senders often provide the IP address of a different host or of the receiving host in the HELO/EHLO statement to obfuscate their presence, or otherwise bypass any restrictions that the MTA 110(M) may have in place for the HELO/EHLO command.

A domain name exploit analyzer 412 seeks to determine a value representing the number of times a sender submits a HELO/EHLO statement that contains a domain name (e.g. host.com) that is included in the list of locally supported domains on the receiving host MTA 110(m). Many malicious senders attempt to obfuscate their identity, or bypass any restrictions applied to the HELO/EHLO command at the MTA 110(m) by presenting themselves as a domain name that is known to be locally supported by the receiving MTA 110(m). For example, a spam sender may connect to foo.com's MTA and issue the HELO statement: “HELO smtpl.foo.com”.

A null data detector 414 may be included to determine a value representing the number of DATA commands from a given sender that are followed by no subsequent data content before being terminated. In many cases, an MTA 110(m) will automatically stamp a received header during this portion of the SMTP transport. In one implementation, this heuristic may be calculated post-transport by measuring the size consumed by the received header and then subtracting the measured size from the overall size of the information presented in the DATA command. In addition to invalid recipient attempts, a malicious sender that is conducting a dictionary attack or namespace mining exercise will often, in cases where invalid RCPT commands are not directly rejected at the SMTP protocol level, proceed with an SMTP session and submit no content via the DATA command. Then, if a non-delivery report (NDR) message returns to the sender, the sender can automate the processing of those messages and reconcile against their attempted recipients to deduce the valid recipients. This heuristic is designed to identify and catch this malicious behavior.

A non-spam distribution analyzer 416 aims to provide a heuristic based on the distribution of good mail versus bad mail over time, where “good” and “bad” are with respect to email content. A definition of bad content, for example, may also include virus, worm, and spam content in email messages. In one implementation, the determination of goodness or badness as applied to email messages can be made with a conventional tool that analyzes email content. Using a suitable conventional message content analysis and categorization tool, a baseline reputation can be established for a sender.

In addition, a non-spam distribution analyzer 416 may gather heuristics according to a time-sliced view. By comparing time slices, a sending machine that may have been compromised and has become malicious may be detected or, alternatively, a machine that has been repaired and has become benign may be detected. For example, if a sender has submitted a total of 100,000 emails to a recipient in the past thirty days and the good email versus bad email volume is currently 98,100 good emails to 1900 bad emails, the distribution represents a fairly clean history. But, if in the past six hours the distribution shifts to 1800 good emails versus 200 bad emails, then the sender may have become compromised since the nature of the sender's delivery behavior and/or content has changed. The sender may now be blocked by the mail blocker 312.

A successful authentication ratio analyzer 418 may also be included to determine a ratio between successful and failed SMTP AUTH attempts from a given sender. Authenticated SMTP connections are typically configured to bypass all MTA level anti-spam processing. A malicious sender may attempt a brute force use of the SMTP AUTH command in order to gain access and ensure their spam email is delivered.

A sender domain analyzer 420 may be included to find various attributes of the sender's domain name, such as first of all whether or not a domain name is provided; whether the domain name belongs to a reputable domain such as “.edu”, “.gov”, or “.mil”; whether the domain—in this context defined as the text resulting from a reverse DNS lookup (or a PTR DNS record) mapping the IP address to a domain—appears to point to a private computer instead of a genuine domain (e.g., contains strings such as “dsl” or “cable”), etc. Typically, malicious senders are the ones that use IP addresses that do not have a domain name. Private computers typically do not send email except when they have been compromised by a malicious sender. Restricted membership domains such as “.gov” and “.mil” typically do not have malicious senders. Although a restricted domain, “.edu” domains frequently act as “forwarders”, relaying email sent to alumni. Such forwarders usually should not be blocked even when they are relaying spam.

Other components may be included in an exemplary heuristics extraction engine 316 for determining additional heuristic indicators that can be used to develop sender reputations.

In one implementation of the statistics engine 306, the reputation rating engine 322 begins formulating a sender's reputation level by starting with a neutral rating. Once a minimum number of messages have been counted by the message counter 328 for the particular sender, a first calculation of the sender's reputation level is performed. This first calculation of a reputation level changes the initial neutral rating to a higher or lower value, establishing this sender as either more trustworthy—as a sender of good email manifesting good sending behavior—or less trustworthy—as a sender of malicious email manifesting objectionable sending behavior. In another implementation, the sender's reputation level is calculated regardless of minimum volume of email messages received from the sender. However, no action is taken using the reputation level value until a minimum volume of emails received from the sender is achieved.

An initial reputation level or a reputation level statistically confirmed by a sufficient volume of emails can be used with a selected threshold by the IP blocker 332, the mail blocker 312, or by an administrator of an MTA 110(M) to prevent attacks or to prevent further connections from the sender. A sender reputation level that is over the selected threshold initiates a block on all email from the sender. This block may take various forms. As described above, the block may be at the IP connection level, a type of block that conserves the most resources for the MTA 110(M) and recipient 202 by avoiding even reception of the sender's email. However, an IP address block may allow the sender to detect that they are being blocked. Alternatively, the above-mentioned non-delivery filter 334 may block by simply causing email messages to not be delivered. This uses more resources, but is less detectable by the sender. This latter type of blocking action may be preferable in many cases, since a sender who can detect the block may just resort to sending spam from another address.

In one implementation, a method of computing a sender reputation level uses a trainable classifier (trainable filter) 324. The trainable filter 324 is trained to gather specific inputs from senders' messages, such as the above heuristics, and to use them to estimate the probability that a sender with these inputs is malicious. The training occurs offline, e.g., outside of a system using the trainable filter 324. In one implementation, the result of training is a set of weights associated with each heuristic. Then at runtime, in a system using the trainable filter 324, the heuristics are examined, weights are added up, and the results are converted into a probability, and/or thresholded, and so on. That is, the probabilities may be thresholded into a set of discrete levels. The sender reputation level is intended to be information about a sender as a whole, not about an individual message, but often the same heuristics and similar techniques can be used to estimate a per-message conditional probability that a message is spam, given its sender.

Given a set of chosen inputs, training the trainable filter 324 may be accomplished across a large collection of senders. The statistical relation between the inputs' values for each sender may be analyzed, e.g., in relation to degree of known maliciousness, thereby producing a set of parameters (“weights”) for a classification function, e.g., a “profiler.” When this function, with these parameters, is applied to the corresponding inputs for a new sender, the function produces an estimate of the probability that the new sender is malicious. Various well-known techniques exist for training classifiers, and one of these may be used to assist training the trainable filter 324.

Being probabilistic, such classifiers make errors, either classifying a benign sender as malicious (a “false positive”), or classifying a malicious sender as benign (a “false negative”). Thus, in some implementations, probability thresholds that determine various sender reputation levels may be selected by a user to provide a reasonable compromise between false positives and false negatives.

Exemplary Procedures

The following discussion describes distributed reputation sender techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. It should also be noted that the following exemplary procedures may be implemented in a wide variety of other environments without departing from the spirit and scope thereof.

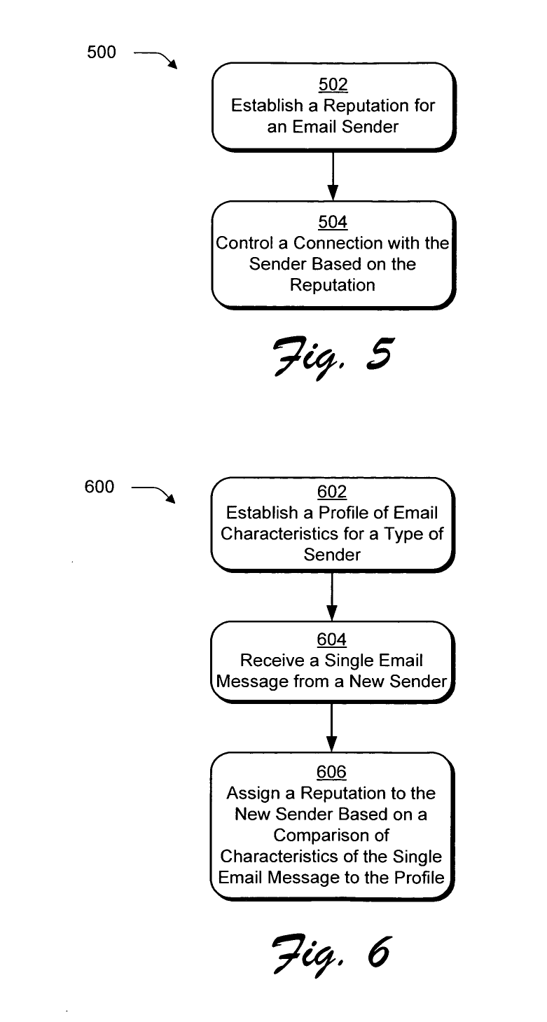

FIG. 5 is a flow diagram depicting a procedure 500 in an exemplary implementation in which control of a connection to an email sender is shown. In the flow diagram, the operations are summarized in individual blocks. The exemplary method 500 may be performed by hardware, software, or combinations of both, for example, by an exemplary SRL engine 220.

A reputation is established for an email sender (block 502). To establish the reputation, multiple delivery characteristics used by the sender and optionally, content characteristics of email messages from the sender, are selected for evaluation. Each characteristic to be evaluated can be viewed as a heuristic, or “rule of thumb” indicator that can be assigned a value representing whether the sender is more or less likely to be malicious or sending unsolicited commercial email, i.e., spam.

In one implementation, a quantity of evaluated values from the delivery characteristics of numerous messages from the sender can be compared, e.g., using a trainable filter 324, with a threshold to determine a reputation level. A greater quantity of email messages subjected to evaluation for tell-tale indications of favorable or unfavorable email behavior often results in a more refined and/or statistically sound reputation for a given sender.

A “nearest neighbor” or a “similarity-based” classifier may be used to arrive at a reputation. Such an exemplary classifier can compare a distribution of the collected indicators, that is, the evaluated delivery characteristics, with a statistical distribution (e.g., a profile) of collected indicators from emails associated with a known type of sender, for example, a malicious sender or a spammer. Similarly, a sender reputation may also be achieved by comparing a distribution of the collected indicators with a distribution profile of collected indicators from a mixture of different types of senders, that is, a profile that represents an average or collective norm. In these latter implementations, the degree of variance from an agreed upon norm or statistical distribution profile can be used to assign a reputation level to a sender.

A connection with the email sender is controlled, based on the reputation established for the sender (block 504). A variety of techniques may be utilized to control a connection, such as throttling (e.g., slowing down connections from a given sender), redirecting to a network or application level quarantine for evaluation, blocking, and so on. If an unfavorable reputation is already established, then a mail blocker 312 may deny connection with the sender. In some implementations, this means that an exemplary SRL engine 220 expends only enough resources to identify the IP address of the sender and then block a connection to the sender.

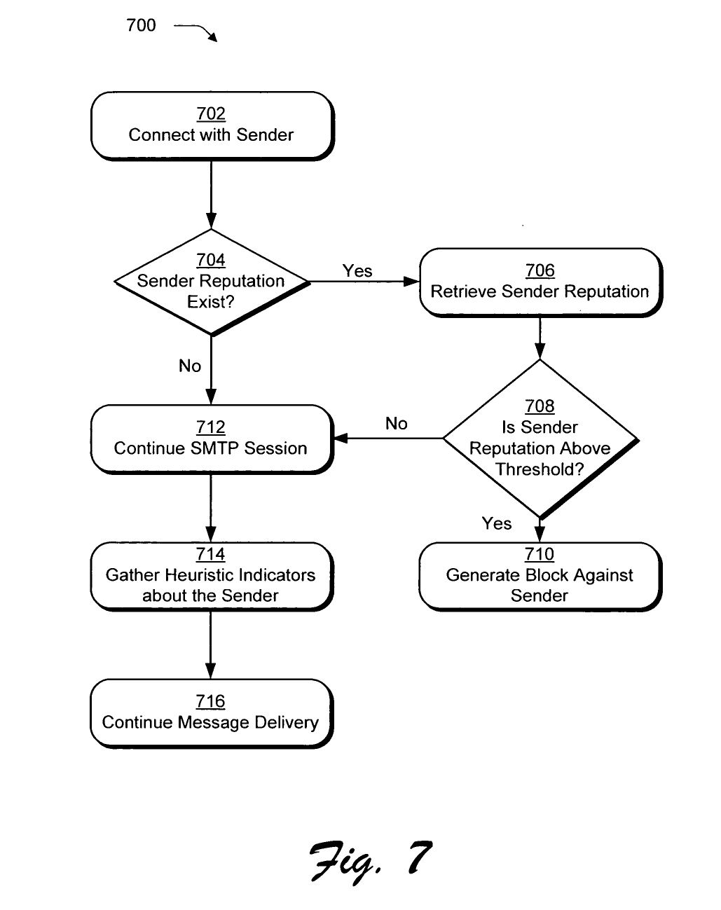

FIG. 6 is a flow diagram depicting a procedure 600 in an exemplary implementation in which a reputation is assigned to a new email sender based on a single email message from the new sender. Heuristics are used to create a profile of characteristics of a hypothetical sender, for example, a hypothetical spam sender. A single email message from a new sender can be parsed for characteristics and compared with the profile to assign a reputation to the new sender on receiving the first email message from the sender. This may occur, for example, in a fingerprint/signature setup, where the first email message matches the signature of a know spam message, and hence is essentially identical to a known spam.

A profile of email characteristics for a type of sender, e.g., a malicious sender, is established (block 602). For example, an exemplary profile may be constructed by a trainable filter 324 and/or a probability engine 326 that can create a map, fingerprint, distribution profile, etc., of email characteristics that typify the type of sender being profiled. That is, each characteristic selected for inclusion in a profile is a heuristic that indicates whether a sender is more or less likely to be the same type of sender that the profile typifies. Examples of characteristics that may serve as heuristics for such a profile are described with respect to FIG. 4.

A single email message is received from a new sender (block 604). The same email characteristics that are used in the profile (e.g., block 602) are evaluated in the received single message from the new sender.

A reputation is assigned to the new sender based on a comparison of the characteristics evaluated in the single email message to the profile (block 606). In other words, a degree of similarity to or variance from a profile of a hypothetical type of sender can allow the reputation of a new sender to be profiled based on a single email. Of course, latitude may be built into an engine performing this procedure 600—a reputation built on a single email message is given much leeway for revision as compared to a sender reputation built upon thousands of emails from the sender. The exemplary procedure 600 may be especially useful when an exemplary SRL engine 220 is used as a “first impression engine” to assign a sender reputation on first contact with the sender.

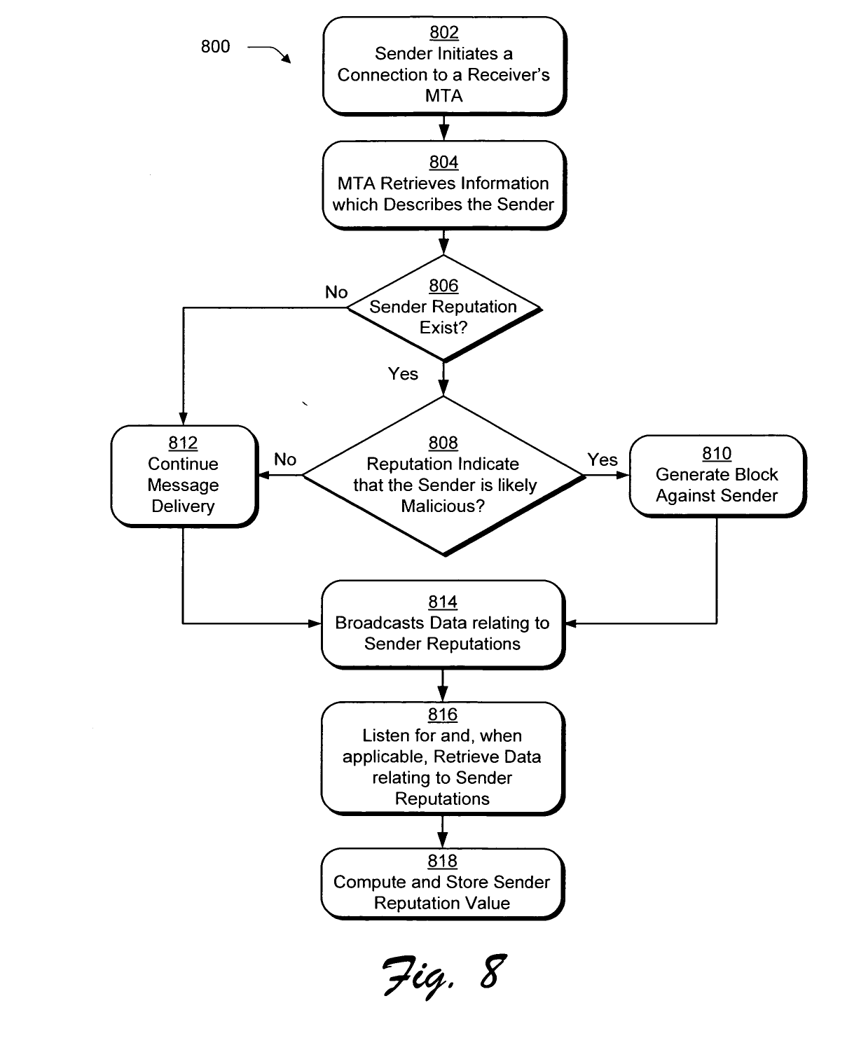

FIG. 7 is a flow diagram depicting a procedure 700 in an exemplary implementation in which a pre-established sender reputation is used and refined. A connection is made with a sender (block 702). The connection may be the initiation of an SMTP connection, and does not imply an open channel over which the sender can send a salvo of email messages to an MTA 110(m). A traffic monitor 300 may control the connection with a sender, e.g., over transport or protocol layers in an MTA 110(m).

An evaluation is performed as to whether a reputation exists (decision block 704), e.g., by checking a sender reputation database 308. If a reputation exists for the sender (“yes” from decision block 704), then the sender reputation is retrieved from the sender reputation database 308 (block 706). In the sender reputation database 308, a sender's reputation may be indexed by whatever form of identity is used by an identity engine 302, for example, a sender's 32-bit IP address, a derivative or hash thereof, and so on.

An evaluation is then performed as to whether the retrieved sender reputation is above a selected threshold (decision block 708). The threshold may be determined by statistical methods, for example, by running a trainable filter 324 against a repository of various email messages. Then, by evaluating how well the threshold separates actual email senders who should have favorable reputations from actual email senders who should have unfavorable reputations, the exemplary method can choose a threshold that gives a desirable tradeoff between the two types of error: i.e., treating a good emailer as bad because its retrieved reputation is above threshold, and treating a bad emailer as good because its retrieved reputation is below threshold. If a given sender reputation is above the threshold (“yes” from decision block 708), that is, if the sender should have an unfavorable reputation, then a block is generated against the sender (block 710). For example, a connection with the sender may be blocked or terminated by a mail blocker 312 that has an IP blocker 332, or email from the sender is filtered out by a non-delivery filter 334. If an IP blocker 332 is used, then subsequent connection attempts from the sender may fail, preventing the sender from submitting more email or consuming more server resources.

If the sender did not yet have an established sender reputation (“no” from decision block 704) or the sender reputation was below a threshold for having an unfavorable reputation (“no” from decision block 708), then the communications session (for example, the SMTP session) continues (block 712).

Heuristics continue to be gathered for refining the sender's reputation (block 714). In some implementations, the procedure 700 may incorporate the new heuristic data into a revised reputation in real time and branch back (e.g., block 708) at this point to evaluate whether incorporation of a relatively few new heuristics has pushed the revised reputation over the threshold. Once heuristics have been gathered and processed, they are merged with the known information retrieved earlier by either overriding Boolean values or updating/incrementing other types of values.

Since the sender either does not have a reputation yet or the reputation is not above the threshold, message delivery from the sender is continued (block 716), and mail is transferred to a recipient 202.

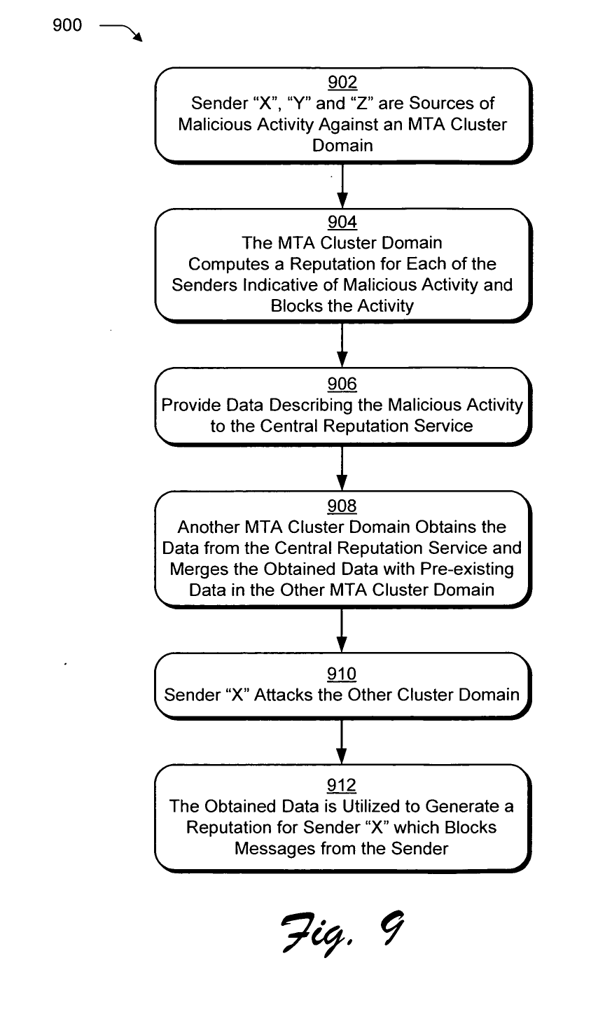

FIG. 8 is a flow diagram depicting a procedure 800 in an exemplary implementation in which message throughput and peer sharing are shown. A sender initiates a connection with an MTA (block 802). For example, the sender may initiate an SMTP connection with a particular MTA to communicate an email.

In response to the connection, the MTA retrieves information which describes the sender (block 804). For example the MTA 110(m) may utilize the data retrieval module 214 via the data access layer 218 to retrieve information from storage 120(m).

A determination is then made as to whether the sender reputation exists (decision block 806). If so (“yes” from decision block 806), a determination is made as to whether the sender is likely a malicious party (decision block 808). For example, the retrieved reputation may indicate that the sender is a spammer, a “phisher” for personally identifiable information, a virus transmitter, and so on. If the reputation indicates that the sender is likely malicious (“yes” from decision block 808), a block is generated against the sender (block 810) as previously described. If the reputation indicates that the sender is not likely to be malicious (“no” from decision block 808), the message delivery is continued (block 812).

Before, during and/or after the performance of the previously described actions (block 802-812), the MTA 110(m) broadcasts data relating to sender reputations (block 814). For example, the broadcast data may include statistics, heuristics, and other data which may be utilized to calculate a reputation. In another example, the broadcast data may include reputations already generated by the MTA 110(m). In a further example, the broadcast data includes the generated reputations and data describing how the reputations were generated. A variety of other examples are also contemplated.

Additionally, the MTA 110(m) may listen for and, when applicable, retrieve data relating to sender reputations (block 816). For instance, the MTA 110(m) may listen for data broadcast by other MTAs in the MTA cluster domain 102. In another instance, the MTA may communicate with the central reputation service 124 to obtain data generated by other MTAs 134(h) in other MTA cluster domains 132. A variety of other instances are also contemplated.

The MTA may then compute and store a sender reputation value (block 818) based on the retrieved data as well as data obtained by monitoring performed by the MTA 110(m) itself. For instance, once heuristics have been gathered and processed, this data may be merged with the known information retrieved earlier by overriding Boolean values, updating/incrementing other types of values, and so on. The SRL engine 220 of the reputation module 116(m) may then compute (for a sender which does not have a reputation) or recompute (for a sender having a reputation) a sender reputation value as previously described. The sender reputation value, along with the data utilized to compute this value, may then be stored in the data persistence store (e.g., storage 120(m)) by instantiating an update with the data persistent module 216 which operates through the data access layer 218.

FIG. 9 is a flow diagram depicting a procedure 900 in an exemplary implementation in which differing MTA cluster domains share data describing senders to thwart an attack by one of the senders. Senders “X”, “Y”, and “Z” are identified as sources of malicious activity against an MTA cluster domain (block 902). For example, the senders may “phish” for personally identifiable information, send spam, transmit viruses, and so on.

The MTA cluster domain computes a reputation for each of the senders that is indicative of the malicious activity and is suitable for blocking the malicious activity (block 904). For example, the reputations may indicate that the senders are malicious such that messages received from those senders are block from being further transmitted. Therefore, the MTA cluster domain may utilize these reputations to successfully block the attack.

The MTA cluster domain then provides data describing the malicious activity to a central reputation service (block 906). For example, the reputation module 116(m) may cause the peer sharing module 212 to be executed to provide an update on it's finding to the central reputation service 124 over the network 106.

Another MTA cluster domain obtains the data from the central reputation service and merges the obtained data with pre-existing data in the other MTA cluster domain (block 908). For example, the other MTA cluster domain 132 may also execute a peer sharing module to communicate with the central reputation service 124 to obtain the data, such as to “pull” the data or have the data “pushed” to the other cluster domain 132. The obtained data is then merged with data previously collected by the other cluster domain 132, such as data obtained through observation of the other cluster domain's 132 personal experience with senders, data previously obtained from the central reputation service 124, and so on. For instance, the other MTA cluster domain 132 may not have encountered traffic from senders “X”, “Y” and “Z” and therefore may have not a reputation or have a “neutral” sender reputation calculated for these senders. While obtaining the data for the senders, it may be determined that the locally calculated sender reputation level is low (i.e., the sender is not considered malicious) but the reputation level provided by the central reputation service is “high”, i.e., indicative that this sender has a relatively good likelihood of being malicious. In such an instance, the reputation level provided by the central reputation service may override the local reputation, thereby helping to protect the other MTA server cluster from attack.

Sender “X”, for instance, may initiate an attack against the other cluster domain (block 910), such as a spam attack, phishing attack, and so forth. The obtained data is utilized to generate a reputation for sender “X” which blocks messages from that sender (block 912). Thus, even though the other MTA cluster domain has never personally experienced traffic from that sender, the other MTA cluster domain is still protected. A variety of other examples are also contemplated, such as through sharing between peers within an MTA cluster domain, sharing between central reputation services, and so on.

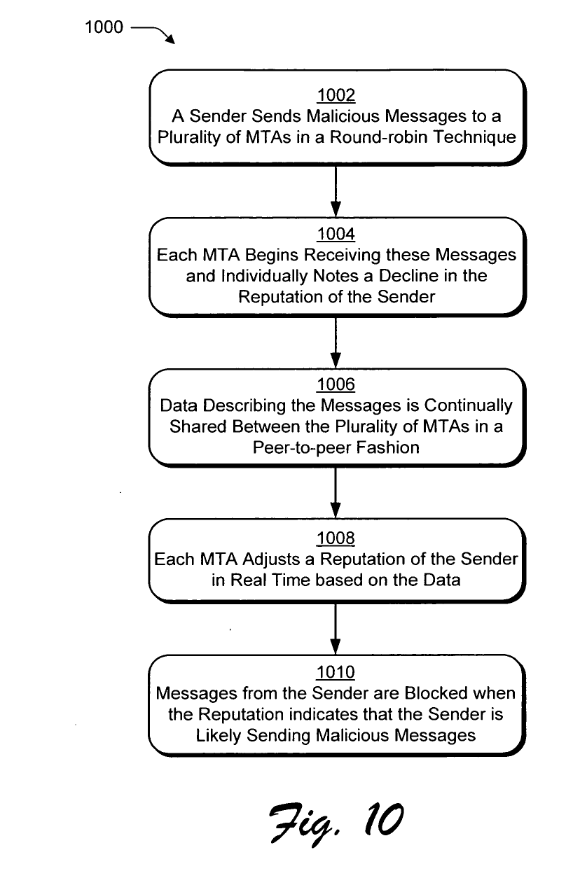

FIG. 10 is a flow diagram depicting a procedure 1000 in an exemplary implementation in which peer-to-peer communication of data which describes senders is communicated between the peers without use of a central reputation service. A sender sends malicious messages to a plurality of MTAs using a round-robin technique (block 1002). For example, the MTA cluster domain 102 may include one hundred MTAs which are arranged to utilize load sharing. In another example, the plurality of MTAs may be distributed between a plurality of MTA cluster domains.

Each of the plurality of MTAs begins receiving these messages and individually notes a decline in a reputation (block 1004), which indicates that the likelihood of the sender being malicious is increasing. Data describing the messages is continually communicated between the plurality of MTAs in a peer-to-peer fashion (block 1006). For example, this data may be communicated between each MTA in an MTA cluster domain. This data may also be communicated between MTAs in different cluster domains.

Each of the plurality of MTAs adjusts a reputation of the sender in real time based on the data (block 1008). The messages from the sender are then blocked when the reputation of the sender indicates that the sender is likely sending malicious messages (block 1010). In this way, each of the plurality of MTAs may leverage their collective experience to thwart attacks.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
evaluating multiple characteristics of message delivery to establish a reputation for a sender of the message by a mail transfer agent; and
sharing data which describes the evaluation with another mail transfer agent.

2. A method as described in claim 1, wherein the data is utilized by each said mail transfer agent to control a connection with the sender.

3. A method as described in claim 1, wherein the data is suitable for generating a reputation by the other mail transfer agent.

4. A method as described in claim 1, wherein the sharing is performed using a peer-to-peer network.

5. A method as described in claim 1, wherein the reputation indicates a relative likelihood that the sender sends malicious messages.

6. A method as described in claim 5, wherein one or more said malicious messages include unsolicited commercial messages, requests for personally identifiable information or messages having viruses.

7. A method as described in claim 1, wherein the message is an email or an instant message.

8. A method as described in claim 1, wherein the sharing is performed through communication of the data over a network to a central reputation service.

9. A method as described in claim 8, wherein the central reputation service is configured to share data aggregated by the central reputation service with another central reputation service.

10. A method as described in claim 1, wherein the mail transfer agent is included in one cluster domain and the other mail transfer agent is included in another cluster domain.

11. A method comprising:
obtaining data from a plurality of mail transfer agents, wherein the data is suitable for generating a reputation to describe a relative likelihood that a sender sends malicious messages; and
aggregating the data in a data repository for communication to one or more said mail transfer agents such that one or more said mail transfer agents establishes a reputation for a sender of the messages received by another one of the plurality of mail transfer agents.

12. A method as described in claim 11, wherein the one or more said mail transfer agents have not received a message from the sender.

13. A method as described in claim 11, wherein the one or more said mail transfer agents adjust a preexisting reputation based on the aggregated data.

14. A method as described in claim 11, wherein the reputation is utilized to control a connection with the sender.

15. A method as described in claim 11, wherein the obtaining and the aggregating are performed by a central reputation service that is accessible to the plurality of mail transfer agents over a network.

16. A method as described in claim 11, wherein a first said mail transfer agent is included in a first cluster domain and a second said mail transfer agent is included in a second cluster domain.

17. A system comprising a plurality of mail transfer agents that are communicatively coupled, one to another, to share data suitable for determining a relative likelihood that a message sender sends malicious messages.

18. A system as described in claim 17, wherein the plurality of mail transfer agents are arranged such that at least one said mail transfer agent is included in a cluster domain and another said mail transfer agent is included in another cluster domain.

19. A system as described in claim 17, further comprising a central reputation service which is configured to aggregate data obtained from the plurality of mail transfer agents.

20. A system as described in claim 17, wherein the plurality of mail transfer agents is communicatively coupled, one to another, over a peer-to-peer network.
